(19) United States
(12) Patent Application Publication
(10) Pub. No.: US 2016/0162753 A1
(43) Pub. Date: Jun. 9, 2016

(54) IMAGE PROCESSING APPARATUS, IMAGE PROCESSING METHOD, AND NON-TRANSITORY COMPUTER-READABLE STORAGE MEDIUM

(71) Applicant: CANON KABUSHIKI KAISHA, Tokyo (JP)

(72) Inventor: Yoshinari Higaki, Kawasaki-shi (JP)

(21) Appl. No.: 14/945,760

(22) Filed: Nov. 19, 2015

(30) Foreign Application Priority Data
Dec. 3, 2014 (JP) 2014-245203

(51) Int. Cl. G06K 9/52; G06K 9/46; G06T 7/60; G06T 7/00

(52) U.S. Cl. CPC G06K 9/52; G06T 7/0085; G06K 9/4604; G06T 7/60; G06K 9/4661

(57) ABSTRACT

An image processing apparatus comprises an edge detector configured to create first image data including information of an edge part of an image obtained by picking up an object by an image pickup device, a frequency analyzer configured to create second image data by dividing the image into each frequency band, and an output unit configured to output distance information from the image pickup device to the object of the image, based on the first image data and the second image data.

### BACKGROUND OF THE INVENTION

1. Field of the Invention

The present invention relates to a technique of estimating a distance from a picked-up image to an object.

2. Description of the Related Art

In recent years, distance estimation techniques are used for image processing in a digital camera, an analysis of a micro scope image, a monitoring camera, ITS (Intelligent Transport Systems) or the like. For practical use of these techniques, it is important to reduce a system for acquiring distance information in size and cost, and to reduce costs of hardware and time required for image processing. Furthermore, in light of changes in an image pickup environment and various applications, it is desirable to perform high-precision distance distribution measurement that does not depend on picking-up scenes. In order to satisfy these requirements, it is an ideal to passively measure distance distribution from an image obtained only by one image pickup system and to maintain the structure of the devices in a conventional image pickup system.

Depth from Defocus (DFD) enables to estimate a distance by quantifying the degree of image blur of obtained images. Moreover, DFD not only satisfies the above-mentioned requirements but also has an advantage capable of reducing the number of picked-up images necessary for estimating the distance. Japanese Patent No. 4403477, U.S. Pat. No. 5,534,924, and Murali Subbarao and Gopal Surya, “Depth from defocus: A spatial domain approach”, International Journal of Computer Vision, 13, 3, pp. 271-294, 1994., and Muhammad Asif and Tae-Sun Choi, “Depth from Defocus Using Wavelet Transform”, IEICE Transactions on Information and Communications, Vol.E87-D, No. 1, pp. 250-253, January 2004. describe the acquisition of distance information using DFD.

Japanese Patent No. 4403477, and Murali Subbarao and Gopal Surya, “Depth from defocus: A spatial domain approach”, International Journal of Computer Vision, 13, 3, pp. 271-294, 1994. and Muhammad Asif and Tae-Sun Choi, “Depth from Defocus Using Wavelet Transform”, IEICE Transactions on Information and Communications, Vol.E87-D, No.1, pp. 250-253, January 2004. disclose the estimation of an object distance using two images or more that have different focuses each other on the basis of geometrical optics. Accordingly, these need driving of lenses, and errors may be caused by the use of geometrical optics. Furthermore, if Fourier Transform is used, noise is caused by division processing of an obtained image, and the accuracy of the distance estimation decreases.

In the case of U.S. Pat. No. 5,534,924, two image sensors are necessary, and it is required to change the structure of the image pickup apparatus from the conventional one.

### SUMMARY OF THE INVENTION

The present invention provides a technique of estimating a high-precision distance to an object from an image obtained by one image pickup apparatus having a structure similar to the conventional one.

An image processing apparatus as one aspect of the present invention includes an edge detector configured to create first image data including information of an edge part of an image obtained by picking up an object by an image pickup device, a frequency analyzer configured to create second image data by dividing the image for every frequency band, and an output unit configured to output distance information from the image pickup device to the object of the image, based on the first image data and the second image data.

A method of processing an image as another aspect of the present invention includes calculating first image data including information of an edge part of an image obtained by picking up an object by an image pickup device, calculating second image data by dividing the image for every frequency band, and outputting distance information from the image pickup device to the object of the image, based on the first image data and the second image data.

Further features and aspects of the present invention will become apparent from the following description of exemplary embodiments with reference to the attached drawings.

### BRIEF DESCRIPTION OF THE DRAWINGS

FIG. 1 is a block diagram of an image pickup apparatus in this embodiment.

FIG. 2 is a block diagram of a distance estimation apparatus in this embodiment.

FIGS. 3A and 3B are flow charts in this embodiment.

FIGS. 4A, 4B, and 4C are diagrams that indicate an original image, a weighting map, and multi-resolution analysis in this embodiment.

FIGS. 5A and 5B are diagrams that indicate the relation between distance and score in this embodiment.

### DESCRIPTION OF THE EMBODIMENTS

Exemplary embodiment of the present invention will be described below with reference to the accompanied drawings.

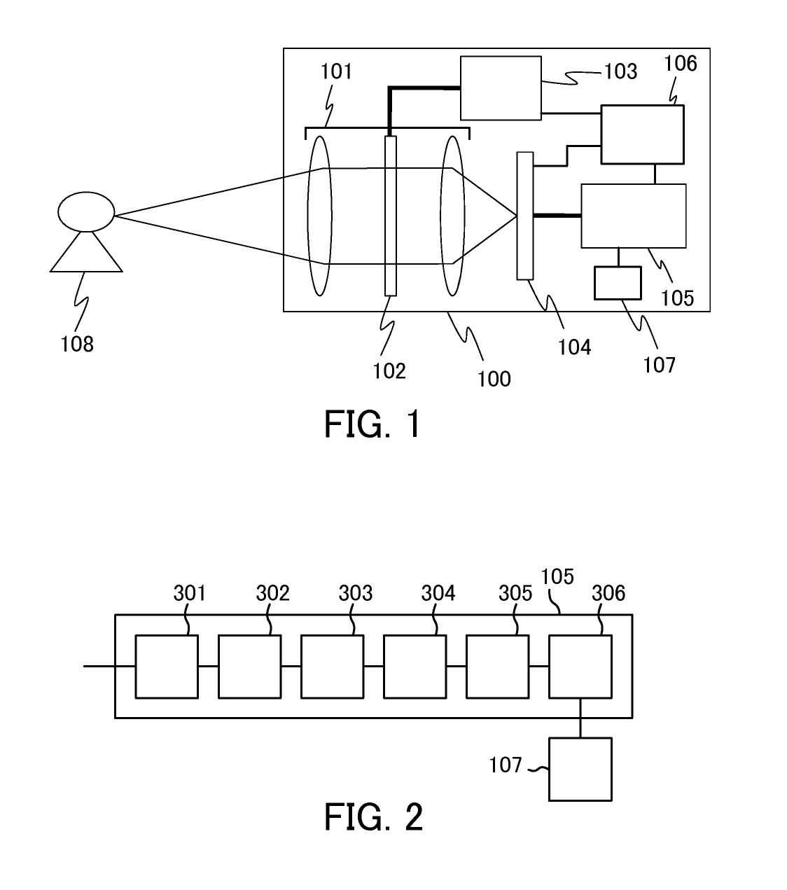

FIG. 1 is a block diagram of an image pickup apparatus in this embodiment. In FIG. 1, an image pickup apparatus 100 includes an image pickup optical system 101, a variable diaphragm 102, a stop driving portion 103, and an image sensor 104, an image processing portion 105, a control portion 106, and a memory portion 107.

The image pickup optical system 101 is composed of a plurality of lenses, and images incident light on the image sensor 104. The image pickup optical system 101 may be a single focus lens or a zoom lens.

The variable diaphragm 102 is disposed in the image pickup optical system 101, and its F value can be adjusted by the stop driving portion 103. The control portion 106 determines conditions of an optical system for picking-up images (hereinafter, simply referred to as “optical condition”), and sends an instruction to a stop driving portion 103 so that the determined condition is achieved to control the variable diaphragm 102. In addition, as a structure of setting optical conditions for picking-up images, for example, a plurality of images are simultaneously or sequentially picked up by not a variable diaphragm but a plurality of optical systems whose numerical apertures are different from each other. If the optical condition is a numerical aperture or an F value, the accuracy of the distance estimation increases as the difference of those values among a plurality of conditions becomes large. Hereinafter, when simply referred to as “distance” or “object distance”, these means the distance between an object and a pupil plane of an image pickup optical system.

The image sensor 104 is an area sensor that is CCD (Charge Coupled Device), CMOS (Complementary Metal-oxide Semiconductor) or the like, in which light-receiving pixels are two-dimensionally arranged. The image sensor 104 converts, into electrical signals, the intensity distribution of light condensed by the image pickup optical system 101, and transmits it to the image processing portion 105. In the structure shown in FIG. 1, an image of the object 108 is formed on the image sensor 104 by the image pickup optical system 101, and the image is transmitted to the image processing portion 105 in the form of electrical signals. In this embodiment, the image sensor 104 picks up a plurality of images in different optical conditions depending on instructions from the control portion 106.

The image processing portion 105 performs processes such as y correction, development, compression, noise elimination, smoothing, edge enhancement and sharpening to the image signals transmitted from the image sensor 104, as needed. While the distance estimation is added to the processes, its procedure may be optimally determined according to its use. The image processing portion 105 may not necessarily perform all the processes.

The image pickup apparatus 100 may include, instead of the image processing portion 105 of Fig.1, a memory that simply accumulates image signals from the image sensor 104. In that case, a calculation apparatus (not shown) including the image processing portion 105 is disposed outside the image pickup apparatus 100, and the image pickup apparatus 100 transmits image data accumulated in the memory to the calculation apparatus, performs the above-mentioned processing, and outputs it to a display apparatus (not shown) as needed. On the basis of the distribution of estimated distance, the obtained image may be processed. For example, on a portrait photograph, a process for emphasizing sharpness of the object may be performed by applying a blur to only its background, in which the distance is relatively large.

In this embodiment, the image processing portion 105 is connected to the memory portion 107, which is a memory, a storage or the like for storing after-mentioned database used for estimating the distance information from the obtained image. This memory portion 107 may be disposed outside the image pickup apparatus 100.

Next, a concrete structure of the image processing portion 105 will be described below.

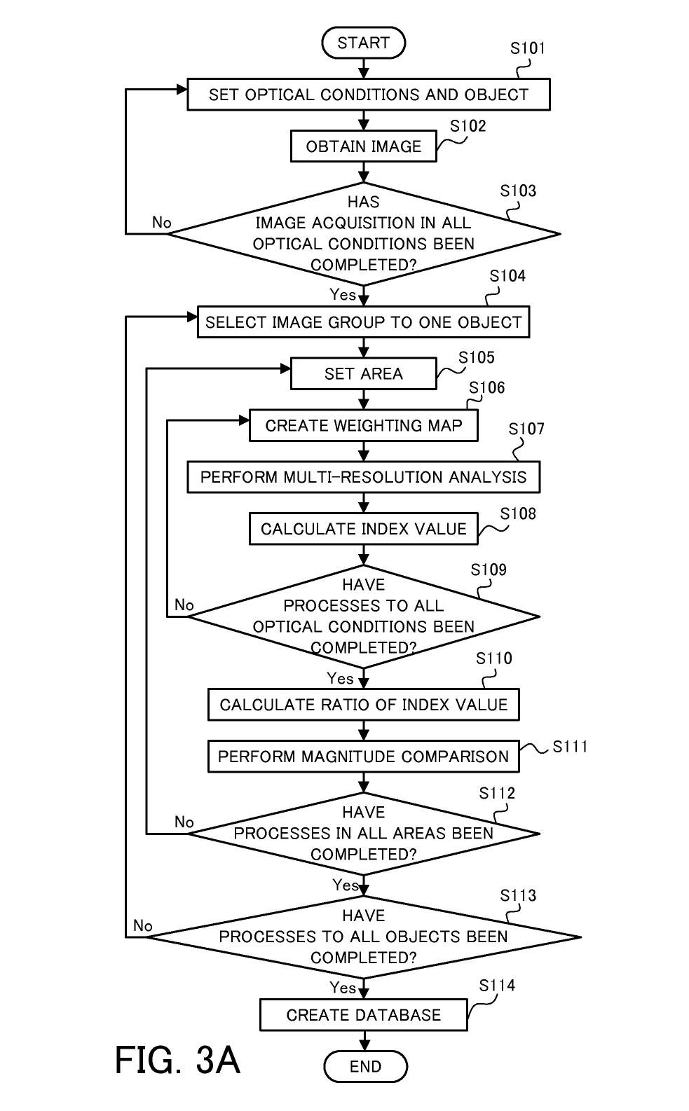

As shown in FIG. 2, the image processing portion 105 includes an area selecting portion 301, an edge detection portion 302, a frequency analyzing portion 303, a calculation processing portion 304, a magnitude comparing portion 305, and a distance information outputting portion 306.

The area selecting portion 301 selects an area in which the object distance is estimated, in each image obtained by the image sensor 104. This provides an estimate of a distance in a selected area even for an image having a nonuniform distance distribution. Moreover, by performing area division based on the distance distribution according to the picking-up scenes in advance, the accuracy of the distance estimation can be improved. The area selecting portion 301 may select an area which a user chose using an input apparatus (not shown), and may select a previously set area. Moreover, it may be determined according to an obtained image. For example, on an obtained image, area division may be automatically performed using an image segmentation method, which is a graph cut, a level set or the like.

The edge detection portion 302 specifies an edge part of an image obtained by the image sensor 104 in an area selected by the area selecting portion 301. An edge part means a part in which the image brightness sharply changes. By performing the edge detection, the contours of the object in the image can be extracted. This embodiment describes that, by calculating the luminance gradient using differences in pixel value between adjacent pixels, the weighting is performed so that values become relatively large in the vicinity of edges in an image to create a weighting map (first image data). In this embodiment, the differentiation in the horizontal direction, that is to say, the differences between the adjacent pixel values are calculated for all the pixels in the above-mentioned area. A periodic boundary condition is assumed in end parts of an image, and it is assumed that the adjacent pixels of pixels of right and left ends of the image are at opposite ends in the same line.

In addition, the weighting map may be formed by convolution operation using a filter of Laplacian or the like, contour extraction using a template matching, methods by other advanced pattern identifications, or the like. Furthermore, if needed, the edge part may be blurred by convolution operation in a finite impulse response as a filtering process, and a binarization process may be performed. The filtering process provides a proper setting of the ratio at which the result of the multi-resolution analysis by an after-mentioned frequency analysis portion 303 is reflected, thereby improving accuracy and stability of the distance estimation. This is because, even in the case where the edge detection is incomplete, more distance information can be obtained by further considering its vicinity. Moreover, the binarization process provides the elimination of the effect of noise, the edge detection method that equivalently handles the vicinity of edges, or the reduction of dependencies to an object, thereby improving accuracy and stability of the distance estimation. For example, even in the case where the object changes, a stable weighting map can be obtained, thereby appropriately selecting an area used in the distance estimation.

When creating the weighting map, the edge detection portion 302 performs down sampling to match its resolution with that of a sub-band image output from the frequency analysis portion 303. The down sampling in this embodiment means that the thinning out of pixels is performed every other pixel in the vertical direction and in the horizontal direction by calculating the average of four pixels in the vicinity of each pixel. The vicinity four pixels may be determined as four pixels in a square area.

The frequency analysis portion 303 performs multi-resolution analysis of images obtained by the image sensor 104. The multi-resolution analysis means a process of dividing image data into plural image data (second image data) having low resolution for every frequency band by repeating a process such as Wavelet Transform, Contourlet transform. Hereinafter, each low-resolution image divided by the transform is referred to as “sub-band image” (image information), and each pixel value of the sub-band image is referred to as “conversion coefficient”.

The multi-resolution analysis provides a spatial distribution of luminance in a specific frequency band. The conversion coefficient indicates pixel information of the frequency band in each pixel. In general, the conversion coefficient of a high-frequency band in the multi-resolution analysis has a characteristic that it attenuates as an obtained image is blurred by the shift of an object from a focus position of an optical system of an image pickup apparatus. This is described in, for example, Shirai Keiichiro, Nomura Kazufumi, Ikehara Masaaki “All-in-Focus Photo Image Creation by Wavelet Transforms” The Institute of Electronics, Information and Communication Engineers (IEICE) Transactions, Vol. J88-A, No. 10, pp. 1154-1162, October 2005. In addition, this reference describes only focus determination, and is silent about a quantitative relationship between Wavelet coefficient and object distance.

The calculation processing portion 304 calculates an index value in each of areas selected by the area selecting portion 301 in one sub-band image, based on the weighting map created by the edge detection portion 302 and the sub-band image obtained by the frequency analysis portion 303. In this embodiment, the average obtained by calculating the product of the conversion coefficient and a value of the weighting map in each of corresponding pixels and dividing it by the number of all pixels of the area selected by the area selecting portion 301 is determined as “index value”. In addition, this calculation is to improve the accuracy of the distance estimation by reflecting the value of the weighting map in the conversion coefficient, and is not limited to multiplication. Moreover, instead of the average, statistical values such as dispersion may be used. These eliminate the noise from the distance information extracted by the frequency analysis portion 303, and enable the distance information to be integrated for each area selected by the area selecting portion 301.

In this embodiment, the calculation processing portion 304 further calculates a ratio of the index values at areas corresponding to each other between images picked up in different optical conditions by the image sensor 104. Hereinafter, the ratio of the index values is referred to as “score^{”}. For example, if the image sensor 104 picks up two images indifferent optical conditions, the calculation processing portion 304 divides an index value of one image by that of the other image. In addition, this calculation is to improve the accuracy of the distance estimation than a case of using only one image, and its result may not be the ratio of index values as long as the relationship of index values in a plurality of images picked up in different optical conditions is reflected. For example, the average of index values of a plurality of images picked up in different optical conditions may be used as the “score”.

The magnitude comparing portion 305 performs magnitude comparison to a plurality of scores obtained from a plurality of sub-band images by the calculation processing portion 304. In this embodiment, the larger of the scores is output.

The distance information output portion 306 collates the score with a database acquired in advance and stored in the memory portion 107, and outputs a value corresponding to the score as a distance to an object located in an area where the score is obtained.

The database may hold a relationship between the distances and scores that are calculated by picking up images of a single or a plurality of objects located at known distance and by using the obtained images. If the plurality of scores disperse depending on the objects at the same distance, the distances and the scores can be related to each other in one to one by extracting respective values such as average. Moreover, data of the scores, which disperse at the same distance, may be used as it is. For example, the outputs from the distance information output portion 306 may be used as a distance range in one area.

The distance information output portion 306 is not limited to a structure that collates the score with the database, and for example a distance corresponding to the score may be calculated using a relational expression derived based on data of distances and scores measured in advance.

The distance distribution information output from the distance information output portion 306 is stored to the memory portion 107. The distance information output portion 306 may be configured to output the distance distribution information to a display apparatus (not shown). Furthermore, the distance information output portion 306 may be configured to perform a process set in advance to one of the obtained images or to a composite image of some of the obtained images according to the distance distribution information.

A method of obtaining data used for the distance estimation by simulation and a method of outputting the distance distribution from an arbitrary image using data obtained by simulation will be described in detail.

In this embodiment, as measurement conditions, wavelength is set at 588.975 nm, two types of F values of an optical system are set at 4 and 12, and a focal length is set at 15.18 mm. Furthermore, a focus position in the object side is assumed to be fixed at a position of 3.5 m along the optical axis from a pupil plane of the optical system. While measurement conditions are not limited to these, the accuracy of the distance estimation can improve as the difference between two types of F values becomes large.

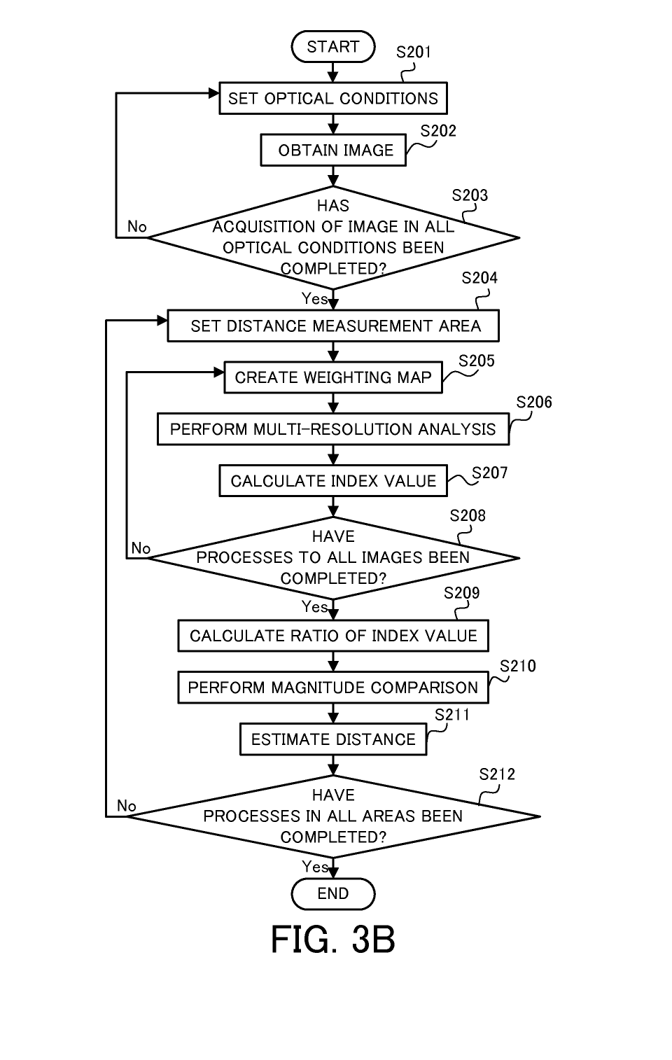

First, a method of a simulation will be described with reference to a flowchart shown in FIG. 3A.

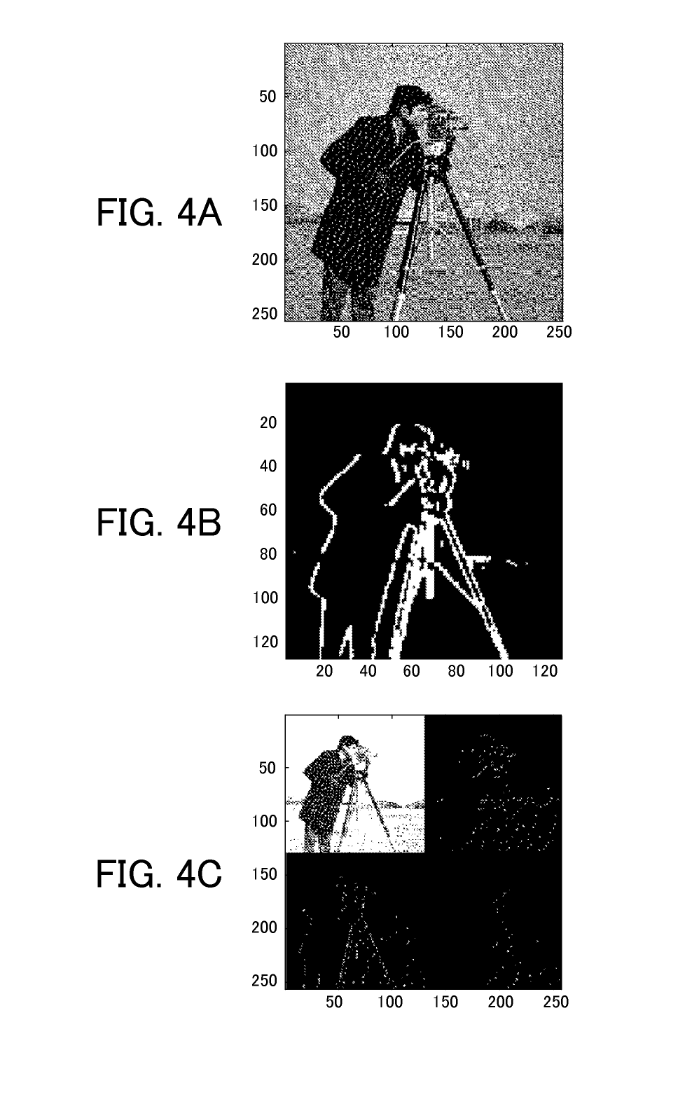

At step S101, the image processing portion 105 sets one of a plurality of optical conditions, selects one of a plurality of original images prepared in advance, and sets the distance between the original image and the pupil plane of the optical system as a predetermined value. In this embodiment, the image processing portion 105 sets an F value as the optical condition as 4 or 12, and selects one of twenty natural images having 320×480 pixels as shown in FIG. 4A , which are prepared in advance, as an original image.

At step S102, the image processing portion 105 obtains an image of the original image corresponding to the condition set in step S101 by image formation calculation based on wave optics. Moreover, at step S102, the image may be actually obtained by an image sensor. This process performed in all combinations of F values, original images, and distances between the original image and the pupil plane of the optical system. In this embodiment, the distance between the original image and the pupil plane of the optical system is changed from 3.5 m to 10 m at 0.5 m intervals. At step S103, the image processing portion 105 determines whether the acquisition of the images in all conditions has been completed. If it has not been completed, it returns to step S101, and if it has been completed, it proceeds to step S104.

At step S104, the image processing portion 105 selects the image group obtained by step S102 to one of the above-mentioned plurality of original images (object). At step S105, the image processing portion 105 (area selecting portion 301) sets one area in the obtained image. For example, the set area may be one of parts where the image is divided by an arbitrary method, and may be a part formed by trimming the other parts in one of a plurality of predetermined areas in the image. In this embodiment, the image processing portion 105 (area selecting portion 301) sets the whole image having 320×480 pixels as one area.

At step S106, by the method described above to the edge detection portion 302, the image processing portion 105 (edge detection portion 302) performs edge detection or contour extraction to the area set at step S105 within one in the image group set in step S104.

Furthermore, at step S106, down sampling is performed by the method described above to the edge detection portion 302. This is because the resolution of each sub-band image obtained by multi-resolution analysis is changed to integral divisions of the obtained image at next step and it is necessary to match the number of pixels of the sub-band image with that of the weighting map.

Moreover, if needed, an after-mentioned filtering process or a binarization process for a processed image may be added. As the filtering process, the convolution operation of the finite impulse response may be used. In general, many functions such as Gaussian function and the rectangular function can be used in the finite impulse response. In the finite impulse response in this embodiment, a Gaussian function of standard deviation 0.5 pixel in an area of 3×3 pixels is used. As a result, an area in consideration of after-mentioned multi-resolution conversion coefficient is extended by blurring a specified edge or contour, thereby improving the accuracy of the distance estimation. Moreover, the binarization process provides the elimination of the effect of noise, the edge detection method that equivalently handles the vicinity of edges, or the reduction of dependencies to an object, thereby improving accuracy and stability of the distance estimation. For example, even in the case where the object changes, a stable weighting map can be obtained, thereby appropriately selecting an area used in the distance estimation. The binarization process in this embodiment sets 30% of the maximum value of the conversion coefficient as a threshold value, and changes the absolute value of the conversion coefficient to 0 in the case where it is not more than the threshold value and to 1 in any other case.

FIG. 4B is an example of a weighting map created in step S106 using the above-mentioned processes. As shown in this example, the weighting map indicates a distribution that is localized around the edge part of the object.

At step S107, the image processing portion 105 (frequency analysis portion 303) performs multi-resolution analysis to one of the image group selected in step S104, and outputs a sub-band image. The multi-resolution analysis in FIG. 3A is performed after the area set in step S105 from the obtained image is extracted, but the area set in step S105 may be extracted from the sub-band image after the multi-resolution analysis is performed in the whole of the obtained image.

In the case of using Wavelet Transform as the multi-resolution analysis, the image processing portion 105 (frequency analysis portion 303) repeats Wavelet Transform by the number of times L (hereinafter, referred to as “level”) specified in advance according to a pyramid algorithm, and finally obtains the 3×L+1 images. Four sub-band images are output with a single Wavelet Transform, and those are classified as LL sub-band, which is a low-frequency band (approximate image), and HL, LH, HH sub-bands, which are high-frequency band. Although, in this embodiment, only HL and LH sub-bands are used because the two sub-bands of HL and LH are especially useful for distance estimation, LL or HH sub-band may be used.

Moreover, in this embodiment, a discrete Wavelet Transform using a scaling function of Haar in L=1 is used as multi-resolution analysis. Other scaling functions include Daubechies and the like, and other transforms include Contourlet, curvelet and the like. Instead, these may be used.

FIG. 4C is an example of results of multi-resolution analysis. Among the four divided images, the upper left is a LL sub-band, the upper right is a HL sub-band, the lower left is a LH sub-band and the lower right is a HH sub-band, and the size of each sub-band image equals to that of an image shown in FIG. 4B. In FIG. 4C, the gradation range is matched with the HH sub-band, and therefore the high value of the display of the LL sub-band is saturated. In addition, the numerical values of the vertical and horizontal axes in FIGS. 4A to 4C represent the number of pixels.

At step S108 shown in FIG. 3A, the image processing portion 105 (calculation processing portion 304) calculates the index value in an area set in step S105 in each obtained image. In this embodiment, the image processing portion 105 (calculation processing portion 304) calculates the product of the weighting map and a pixel value of one converted image in each pixel, and outputs the average of all the pixels as the index value. This process is performed to both of the above-mentioned HL and LH sub-bands.

At step S109, the image processing portion 105 determines whether the processes from step S106 to step S108 have been performed to all the optical conditions. If they have not been performed to all the optical conditions, it returns to step S106, and if they have been performed to all of them, it proceeds to step S110.

At step S110, the image processing portion 105 (calculation processing portion 304) calculates, for index values obtained from images picked up in different optical conditions, a ratio (score) of the index values of their picked-up images. In this embodiment, the image processing portion 105 (calculation processing portion 304) divides index values calculated from images picked up at F value of 12 by those at F value of 4, and outputs the score. Since the index values are obtained from two sub-bands of HL and LH, two scores are output.

At step S111, the image processing portion 105 (magnitude comparing portion 305) performs magnitude comparison to a plurality of scores obtained from a plurality of sub-band images, and outputs the largest one. In this embodiment, the image processing portion 105 (magnitude comparing portion 305) outputs a larger one of two scores obtained from the index values of two sub-bands HL and LH.

At step S112, the image processing portion 105 determines whether the processes from step S105 to step S111 have been performed in all the areas. If they have not been performed in all the areas, it returns to step S105, and if they have been performed in all the areas, it proceeds to step S113.

At step S113, the image processing portion 105 determines whether the processes from step S104 to step S112 have been performed to all the objects. If they have not been performed to all the objects, it returns to step S104, and if they have been performed to all the objects, it proceeds to step S114.

At step S114, the image processing portion 105 creates a database where the relationship between the object distance and the score for each of the selected original image and the set area is stored and which is used for distance estimation. If one distance estimation value is output to one position in an image in distance estimation, a database where the score and the distance correspond to each other in one to one is required. Therefore, if a plurality of scores are obtained by a known distance according to original images or according to areas, they are replaced with a respective value such as their average. On the other hand, if an estimation range of the distance is output to one position in an image in distance estimation, it is unnecessary that the score and the distance in the database correspond to each other in one to one.

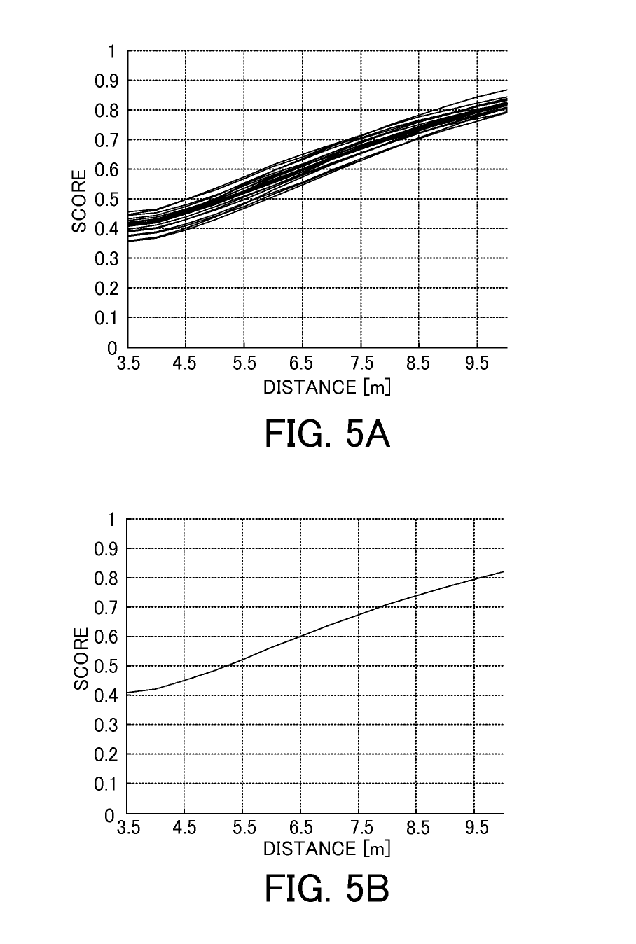

The series of processes shown in FIG. 3A creates a database for estimating a distance from a score. In this embodiment, FIGS. 5A and 5B show a database that is created using twenty original images by setting the whole of the image as one area. In FIG. 5A, the score (vertical axis) is dispersed against one distance (horizontal axis), caused by the difference between a luminance distribution and its statistical property in accordance with an original image. FIG. 5B shows the average of the score, which is calculated to output one distance estimation value at one position in distance estimation, and the score (vertical axis) corresponds to one distance (horizontal axis) in one to one.

A process for estimating a distance by the image processing portion 105 from a plurality of images of a distance-unknown object picked up by the image pickup apparatus 100 in different optical conditions will be described with reference to a flowchart shown in FIG. 3B. In addition, a flow shown in FIG. 3B may be executed in the control portion 106 arranged inside the image pickup apparatus 100, and may be executed in a control portion (not shown) arranged outside the image pickup apparatus 100 or executed in the image processing portion 105.

Firstly, at step S201, the image processing portion 105 sets one among the plurality of optical conditions. In this embodiment, the image processing portion 105 sets F value to 4 or 12. At step S202, the image processing portion 105 transmits instruction via the control portion 106 to the stop driving portion 103 so as to provide the optical condition set in step S201, and picks up an image of an object by the image sensor 104. At step S203, the image processing portion 105 determines whether the acquisition of the image in all the optical conditions has been completed. If it has not been completed, it returns to step S201, and if it has been completed in all the optical conditions, it proceeds to step S204.

At step S204, as with step S105, the image processing portion 105 (area selecting portion 301) sets one area in the obtained image. In this embodiment, the whole image having 320×480 pixels is set as one area.

At step S205 to step S208, the image processing portion 105 (edge detection portion 302, frequency analysis portion 303, calculation processing portion 304) performs processes similar to step S106 to step S109 in each of the areas selected in step S204. As a result, in this embodiment, two index values corresponding to two obtained images are output from each of two sub-bands of HL and LH. In other words, four index values in total are output.

At step S209, as with step S110, the image processing portion 105 (calculation processing portion 304) calculates, for index values obtained from images picked up in different optical conditions, a ratio (score) of the index values of their picked-up images. In this embodiment, the image processing portion 105 (calculation processing portion 304) divides index values calculated from images picked up at F value of 12 by those at F value of 4, and outputs the score. Since the index values are obtained from two sub-bands of HL and LH, two scores are output.

At step S210, the image processing portion 105 (magnitude comparing portion 305) performs magnitude comparison to a plurality of scores obtained from a plurality of sub-band images, and outputs one. In this embodiment, the image processing portion 105 (magnitude comparing portion 305) outputs a larger one of two scores obtained from the index values of two sub-bands HL and LH.

At step S211, the image processing portion 105 (distance information outputting portion 306) refers to the database created in step S114, and outputs the distance estimation value corresponding to the score obtained in step S209. For example, if the object is captured at distance 7.00 m and the score 0.63 is obtained by the processes up to step S209, the distance estimation value corresponding to the score 0.63 is calculated as 6.91 m by spline interpolation of the database shown in FIG. 5B.

Since the true distance of this object is 7.00 m, the error in the distance estimation is 0.09 m.

At step S212, the image processing portion 105 determines whether all the processes from step S204 to step S211 have been performed in all the areas. If they have not been performed in all the areas, it returns step S204, and if they have been performed in all the areas, this flow ends. As a result, if an obtained image is divided to a plurality of areas, steps S204 to S211 are repeated until the processes in all the areas are completed, and a distance map can be created by estimating a distance in each area.

Moreover, the distance map may be obtained by the following method. For example, it is a method of scanning a rectangular area having a constant size in the obtained image by a movement width corresponding to the resolution of the distance map, and of performing the processes from step S204 to step S211 every the movement of the rectangular area. By repeatedly substituting the value of the distance estimated in step S210 for a pixel corresponding to the center position of the rectangular area every the movement of the rectangular area, the distance map can be obtained at the time when the scanning of the rectangular area is finished. Therefore, even if the distance of the object is uneven in the whole of the obtained image, an uneven distance map can be obtained. The method for obtaining the distance map is not limited to above, and the size of the rectangular area and the movement width of the scanning may be set voluntarily.

As above, according to this embodiment, the distance to an object can be accurately estimated based on imaged obtained by one image pickup apparatus having the same structure as before.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD) TM), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-245203, filed on Dec. 3, 2014, which is hereby incorporated by reference herein in its entirety.

What is claimed is:

1. An image processing apparatus comprising:
an edge detector configured to create first image data including information of an edge part of an image obtained by picking up an object by an image pickup device;
a frequency analyzer configured to create second image data by dividing the image for every frequency band; and
an output unit configured to output distance information from the image pickup device to the object of the image, based on the first image data and the second image data.

2. The image processing apparatus according to claim 1, further comprising a processor configured to perform calculation processing between the first image data and the second image data,
wherein the output unit is configured to output the distance information from the image pickup device to the object of the image, based on an index value obtained by the calculation processing.

3. The image processing apparatus according to claim 2, wherein the edge detector and the frequency analyzer create the first image data and the second image data for each of a plurality of images obtained by picking up the object in the different conditions, and
wherein the output unit is configured to output distance information from the image pickup device to the object, the distance information corresponding to a ratio of the index values of the plurality of images.

4. The image processing apparatus according to claim 3, further comprising a memory in which a relationship the ratio of the index value and a distance from the image pickup device to the object is stored in advance,
wherein the output unit is configured to output the distance information from the image pickup device and the object of the image by referring to the memory, the distance information corresponding to the ratio of the index value.

5. The image processing apparatus according to claim wherein the edge detector is configured to create the first image data by calculating a luminance gradient between pixels.

6. The image processing apparatus according to claim wherein the edge detector is configured to create the first image data by performing a convolution operation of finite impulse response to the edge part.

7. The image processing apparatus according to claim 1, wherein the edge detector is configured to create the first image data by performing a binarization process to the edge part.

8. The image processing apparatus according to claim 1, wherein the second image data is image information in high-frequency band of the image.

9. The image processing apparatus according to claim 2, wherein the processor is configured to calculate a product of the first image data and the second image data in each pixel and to output an average of calculated products as the index value.

10. The image processing apparatus according to claim 2, further comprising a magnitude comparer configured to perform magnitude comparison to the index value,
wherein the second image data include plural image information obtained by dividing the image for every frequency band,
wherein the processor is configured to perform the calculation processing to each of the plural image information with the first image data,
wherein the magnitude comparer is configured to perform the magnitude comparison to a plurality of index values obtained by the calculation processing, and
wherein the output unt is configured to output the distance information from the image pickup device to the object of the image, based on an index value determined by the magnitude comparison.

11. A method of processing an image, the method comprising:
calculating first image data including information. of an edge part of an image obtained by picking up an object by an image pickup device;
calculating second image data by di iding the image for every frequency band; and
outputting distance information from the image pickup device to the object of the image, based on the first image data and the second image data.

12. A non-transitory computer-readable storage medium storing a program to cause a computer to execute a method of processing an image, the method comprising:
calculating first image data including information of an edge part of an image obtained by picking up an object by an image pickup device;
calculating second image data by dividing the image for every frequency band; and
outputting distance information from the image pickup device to the object of the image, based on the first image data and the second image data.
